(19) United States
(12) Patent Application Publication
(10) Pub. No.: US 2007/0115707 A1
(43) Pub. Date: May 24, 2007

(54) Vehicle auxiliary machine having an inverter circuit

(75) Inventor: Tatsuya Koide, Kariya-shi (JP)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Kabushiki Kaisha Toyota Jidoshokki, Kariya-shi (JP)

(21) Appl. No.: 11/584,396

(22) Filed: Oct. 19, 2006

(30) Foreign Application Priority Data
Oct. 20, 2005 (JP) 2005-305808

(51) Int. Cl. H02M 1/12

(52) U.S. Cl. 363/146; 307/116; 363/131; 363/41; 363/56.04; 180/68.5

(57) ABSTRACT

A vehicle auxiliary machine having an inverter circuit includes an inverter cover, an inverter cover fastening member, an interlock plate and an interlock switch mechanism. The inverter cover covers the inverter circuit. The inverter cover fastening member is provided for fastening the inverter cover to the vehicle auxiliary machine. The interlock plate covers the inverter cover fastening member and is detachably fastened to the inverter cover. The interlock switch mechanism is operable in accordance that the interlock plate is removed from a predetermined position of the inverter cover.

### BACKGROUND OF THE INVENTION

The present invention relates to a vehicle auxiliary machine having an inverter circuit.

Japanese Patent Application Publication No. 2004-190547 discloses a motor-driven compressor which is provided with an inverter. This motor-driven compressor has on its housing an inverter circuit which is enclosed by an inverter cover (or cover plate). Once the compressor has been mounted on a vehicle, maintenance service such as checking and replacement of the inverter circuit is performed with the compressor mounted on the vehicle. Because the inverter circuit has a part that generates a high voltage, serviceman must take great care not to touch the inverter circuit during servicing work.

On the other hand, Japanese Utility Model Application Publication No. 59-99660 discloses an electrical generator having an openable protection cover for enclosing a wiring terminal in the electrical generator, wherein the operation and stop of an engine for driving the electrical generator is switched in response to the detection of the condition of this cover whether it is opened or closed. In this electrical generator, as a bolt for fastening the protection cover is removed and the protection cover then located at its closed position initiates to open, a detection switch is operated to detect a movement of the protection cover away from the closed position and the engine is stopped accordingly. For ensuring safety in the maintenance service of an inverter, the invention disclosed in the above Publication No. 59-99660 may be used for detection of removal of the inverter cover in the motor-driven compressor disclosed in Japanese Patent Application Publication No. 2004-190547, thus preventing a high voltage from being generated in the inverter circuit while the inverter cover is being removed.

Even if the generation of high voltage is prevented when the inverter cover has been removed from a predetermined closed position, however, high voltage exists in the inverter circuit before removal of the inverter cover. For example, when serviceman touches the inverter cover to loosen bolts fastening the inverter cover, the inverter circuit continues generating high voltage. Furthermore, when the inverter cover is mounted on the mounting base after removal of bolts, the serviceman puts his fingertips into the gap between the inverter cover and the mounting base and possibly touch the inverter circuit generating high voltage when he attempts to lift the inverter cover for removal. Thus, it is desirable that no high voltage exists in the inverter circuit when loosening the bolts in beginning the maintenance service of the inverter circuit.

The present invention is directed to a vehicle auxiliary machine having an inverter circuit, which allows serviceman to work under a safer environment in the beginning of maintenance work of the inverter circuit.

### SUMMARY OF THE INVENTION

In accordance with a first aspect of the present invention, a vehicle auxiliary machine having an inverter circuit includes an inverter cover, an inverter cover fastening member, an interlock plate and an interlock switch mechanism. The inverter cover covers the inverter circuit. The inverter cover fastening member is provided for fastening the inverter cover to the vehicle auxiliary machine. The interlock plate covers the inverter cover fastening member and is detachably fastened to the inverter cover. The interlock switch mechanism is operable in accordance that the interlock plate is removed from a predetermined position of the inverter cover.

In accordance with a second aspect of the present invention, a method for opening an inverter cover of a vehicle auxiliary machine includes the steps of loosening an interlock plate fastening member, removing an interlock plate which covers an inverter cover fastening member from a predetermined position, stopping power supply to an inverter circuit unit, loosening the inverter cover fastening member, and removing the inverter cover only after removal of the interlock plate.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a side view of a motor compressor having an inverter circuit according to a first preferred embodiment of the present invention;

FIG. 2 is a plan view of the motor compressor having the inverter circuit according to the first preferred embodiment of the present invention;

FIG. 3 is a front end view of the motor compressor having the inverter circuit according to the first preferred embodiment of the present invention; and

FIG. 4 is a longitudinal cross-sectional view showing peripheries of an interlock switch mechanism of the motor compressor according to the first preferred embodiment of the present invention.

### DETAILED DESCRIPTION OF THE PREFERRED EMBODIMENTS

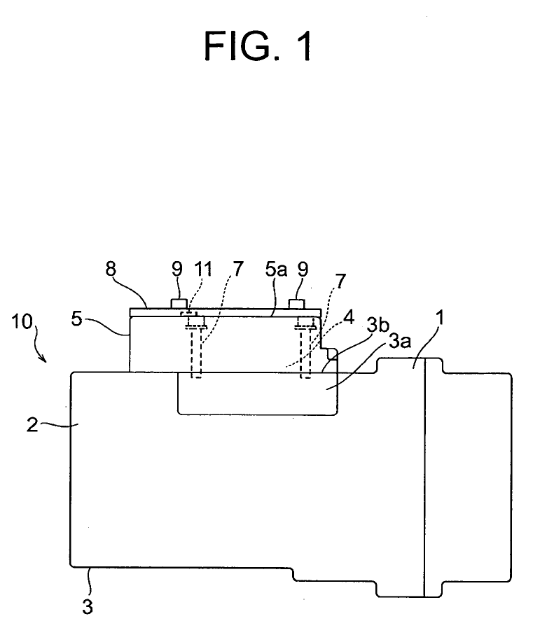

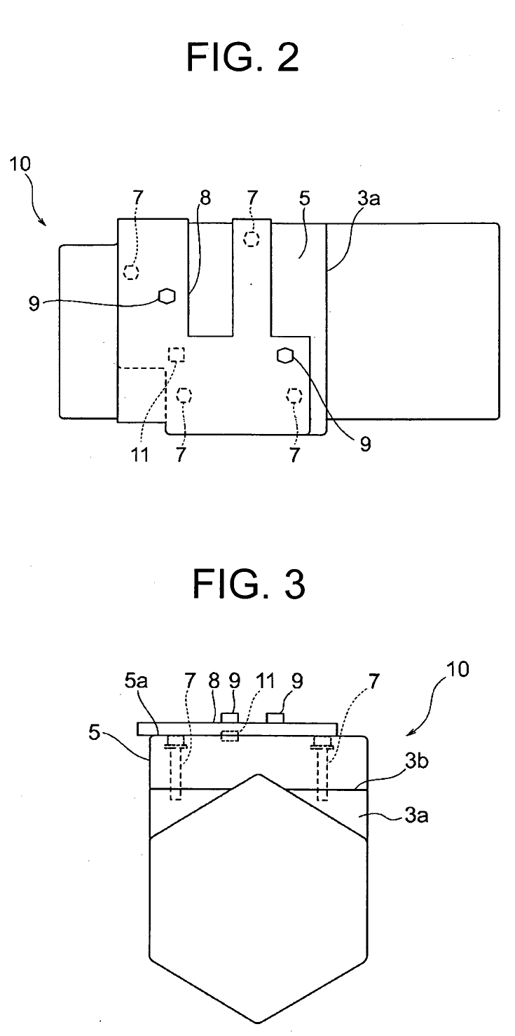

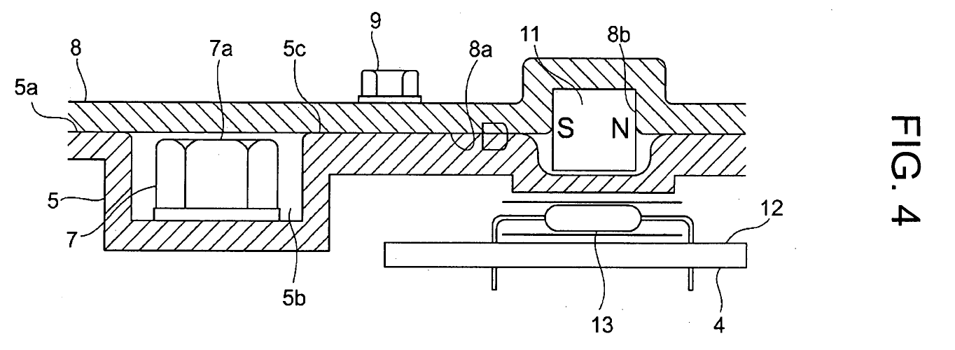

The following will describe a first preferred embodiment of a vehicle auxiliary machine having an inverter circuit, that is, a motor compressor with a built-in inverter circuit, with reference to FIGS. 1 through 4. Referring to FIG. 1, the motor compressor 10 with a built-in inverter circuit includes a compressor unit 1 which is a part of refrigerant circuit for vehicle air conditioner, a motor unit 2 or a three-phase synchronous motor for driving the compressor unit 1, a housing 3 which accommodates therein the compressor unit 1 and the motor unit 2, and an inverter circuit unit 4 having an inverter circuit for controlling the operation of the motor unit 2. The housing 3 is provided on its upper surface with a mounting base 3a having a mounting surface 3b facing upward. The mounting base 3a has the inverter circuit unit 4 mounted therein. The inverter cover 5 is connected to the mounting surface 3b through a seal gasket (not shown) and fastened thereto by four inverter cover fastening bolts 7 (FIG. 2) which are inverter cover fastening members of the present invention. A plate-like interlock plate 8 is mounted on the upper surface 5a of the inverter cover 5 so as to cover all four bolts 7. The interlock plate 8 is fastened to the inverter cover 5 by interlock plate fastening bolts 9 which are interlock plate fastening members in this embodiment.

As clearly shown in FIG. 4, the upper surface 5a of the inverter cover 5 facing the interlock plate 8 has recesses 5b for accommodating therein heads 7a of the bolts 7. The upper surface 5a of the inverter cover 5 serves as a facing surface that faces the interlock plate 8 and the part of the upper surface 5a which is in contact with the interlock plate 8 when the interlock plate 8 is assembled will be referred to as the contact surface 5c. The head 7a of each bolt 7 accommodated in the respective recess 5b does not project beyond the contact surface 5c when the inverter cover 5 is completely fastened by the bolts 7 to the mounting base 3a.

Part of the lower surface 8a of the interlock plate 8 is recessed so as to form a recess 8b. The lower surface 8a of the interlock plate 8 provides a facing surface in facing relation to the inverter cover 5, while the recess 8b provides a magnet-mounting portion in which a magnet 11 is fixedly buried. As seen in FIG. 4, hexagon head bolts are used as the bolts 9. On the other hand, the bolts 7 for fastening the inverter cover 5 have a shape that is different from that of the bolts 9 and are fastened with a special tightening tool. Thus, the bolts 9 are not fastened with the tightening tool designed for the bolts 7.

The inverter circuit unit 4, which is designed to control the operation of the motor unit 2 by converting direct current into alternating current, has inverter circuit components (not shown). The inverter circuit components include a power semiconductor module (a power switching device), a power terminal of the three-phase inverter circuit, a ground terminal and a smoothing capacitor connected between the terminals for absorbing high-frequency component of switching electric current of the three-phase inverter circuit. The inverter circuit components form upper arm switching device and lower arm switching device of each phase of the three-phase inverter circuit. The inverter circuit unit 4 and the inverter circuit components are electrically connected through the printed circuit 12. The printed circuit 12 implements a controller thereon. This controller has a function of on-off controlling of each semiconductor module in accordance with external commands and a function to transmit signals which are indicative of driving condition of the motor unit 2, and is formed of various devices such as CPU and ICs electrically connected by printed circuit.

In addition, the printed circuit 12 includes a reed switch 13 which is operable in response to close proximity to a magnet. The reed switch 13 corresponds to a magnetic reaction switch of the present invention. The reed switch 13 is used to connect and disconnect the input power supplied to the inverter circuit unit 4 by on-off operation, thereby to prevent generation of high voltage in the inverter circuit unit 4 when the reed switch 13 is off or supply of the input power to the inverter circuit 4 is interrupted. As the magnet approaches the reed switch 13, the reed switch 13 turns on, thus enabling power supply to the inverter circuit unit 4. On the other hand, as the magnet is moved away from the reed switch 13, the reed switch 13 turns off, thus stopping power supply to the inverter circuit unit 4. The reed switch 13 and the magnet 11 cooperate to form an interlock switch mechanism which is operable in accordance that the interlock plate 8 is removed from a predetermined position of the inverter cover 5.

Work procedure for opening the inverter cover 5 in checking or replacing any components of the inverter circuit unit 4 of the motor compressor 10 will now be described. To remove the inverter cover 5 that encloses the inverter circuit unit 4 of the motor compressor 10, the bolts 7 need be loosened. However, the interlock plate 8 which covers the bolts 7 must be removed firstly. Therefore, the bolts 9 are firstly loosened. As the bolts 9 are loosened with a general tightening tool and the interlock plate 8 is then removed from its predetermined position, the reed switch 13 turns off thereby to stop power supply to the inverter circuit unit 4. Thus, the inverter cover 5 is removed only after removal of the interlock plate 8, so that no electric power is supplied to the inverter circuit unit 4 during loosening the bolts 7. This permits the serviceman to loosen the bolts 7 under safe conditions where no high voltage is generated in the inverter circuit unit 4. All bolts 7 are removed to open the inverter cover 5, and the maintenance of the inverter circuit unit 4 is then performed.

The following will describe a procedure for mounting the removed interlock plate 8 and the inverter cover 5 after the maintenance of the inverter circuit unit 4. Firstly, the inverter cover 5 is mounted on the mounting surface 3b. The bolts 7 are tightened with the special tightening tool to fix the inverter cover 5 to the mounting surface 3b. Then, the interlock plate 8 is placed on the inverter cover 5. Here, it should be confirmed that all bolts 7 to be covered with the interlock plate 8 are securely tightened. Since the bolts 9 for fastening the interlock plate 8 can be tightened only by using a tightening tool that is different from that for the bolts 7, the tightening tool must be changed to fasten the interlock plate 8 to the inverter cover 5. This precludes such a working procedure that the bolts 7 and the bolts 9 are tightened with the same tool successively without changing the tool. Thus, it hardly occurs that the bolts 9 are tightened without tightening any of the bolts 7. Subsequently, the bolts 9 are tightened to the interlock plate 8 thereby to fix the interlock plate 8 to the inverter cover 5. As the interlock plate 8 is engaged with the inverter cover 5 at the predetermined fitting position, the reed switch 13 is turned on, thus enabling power supply to the inverter circuit unit 4.

As described above, the bolts 7 cannot be loosened until the interlock plate 8 that covers the bolts 7 is removed. As the interlock plate 8 is removed, the interlock switch operates to stop generation of high voltage in the inverter circuit unit 4. When the bolts 7 that fasten the inverter cover 5 are being loosened after removal of the interlock plate 8, high voltage is generated no more in the inverter circuit unit 4, so that the maintenance work of the inverter circuit is performed with safety.

Because all bolts 7 are covered with the interlock plate 8, the reed switch 13 will be turned off, if part of the loosened interlock plate 8 is raised so that some of the bolts 7 are not covered any more with the interlock plate 8. Thus, high voltage is generated no more in the inverter circuit unit 4 when workman begins to loosen any bolt 7, so that the maintenance of the inverter circuit is further safely performed. Since the recesses 5b are formed in the inverter cover 5, the heads 7a of the bolts 7 do not project beyond the contact surface 5c. Thus, the inverter circuit unit 4 may be made with reduced height, with the result that the size of the inverter circuit unit 4 is reduced.

The interlock plate 8 is fastened to the inverter cover 5 by the bolts 9 that have a shape that is different from that of the bolts 7. Tightening of these different bolts 7, 9 requires the use of different tightening tools. Since the servicing work is thus interrupted before tightening the bolts 9, confirmation of installation and tightening of the bolts may be performed reliably.

The interlock plate 8 has the magnet 11, and the reed switch 13 is provided on the side of the inverter circuit 4 in opposition to the magnet 11 with the inverter cover 5 disposed therebetween. The reed switch 13 serves as a noncontact sensor which is operable to detect magnetic field of the magnet 11, so that the combination of the magnet 11 and the reed switch 13 provide a highly durable interlock switch mechanism. In addition, the reed switch 13 is located in the inverter circuit unit 4, so that it is influenced much less by heat in comparison to a case wherein the reed switch is provided adjacent to the motor compressor 10 and, therefore, the reed switch 13 can provide improved detecting operation. Furthermore, the reed switch 13 is arranged on the substrate of the existing inverter circuit, so that no additional support member for the reed switch 13 is required, thus providing an interlock switch mechanism that is low in cost. Because the magnet 11 is located in the recess 8b of the interlock plate 8, the addition of the interlock plate 8 does not significantly increase the space in height direction of the inverter circuit unit 4. The location of a magnet and a reed switch is not limited to the illustrated embodiment. The inverter cover 5 may have a magnet 11 A, and a reed switch 1 3A may be provided on the side of the interlock plate 8 in opposition to the magnet 11A with the interlock plate 8 disposed therebetween.

In the above-preferred embodiment, the invention has been described as applied to a motor compressor that incorporates therein an inverter circuit, but the present invention is applicable to any vehicle's auxiliary machine as far as it has an inverter circuit. The present invention is applicable also to vehicle auxiliary machines that can incorporate an inverter circuit, such as alternators, starters, front motors and rear motors for hybrid car. The interlock plate does not need to have a plate-like shape, but it may be of any shape as far as it can cover the inverter cover fastening member and be detachably fastened to the inverter cover. A magnet and a magnet reaction switch are used as an interlock switch mechanism in the illustrated embodiment of the invention, but other sensing and switching devices are applicable, if the devices sense the removal of the interlock plate and stop the power supply to the inverter.

Therefore, the present examples and embodiments are to be considered as illustrative and not restrictive, and the invention is not to be limited to the details given herein but may be modified within the scope of the appended claims.

What is claimed is:

1. A vehicle auxiliary machine having an inverter circuit, comprising:
an inverter cover covering the inverter circuit;
an inverter cover fastening member for fastening the inverter cover to the vehicle auxiliary machine;
an interlock plate covering the inverter cover fastening member and detachably fastened to the inverter cover; and
an interlock switch mechanism operable in accordance that the interlock plate is removed from a predetermined position of the inverter cover.

2. The vehicle auxiliary machine according to claim 1, wherein a plurality of the inverter cover fastening members is provided, and all the inverter cover fastening members are covered with the interlock plate.

3. The vehicle auxiliary machine according to claim 1, wherein a surface of the inverter cover facing the interlock plate has a recess for accommodating therein a head of the inverter cover fastening member so that the head of the inverter cover fastening member does not project beyond a contact surface of the inverter cover that is in contact with the interlock plate when the interlock plate is assembled.

4. The vehicle auxiliary machine according to claim 1, wherein the interlock plate is fastened to the inverter cover by an interlock plate fastening member that has a different shape from the inverter cover fastening member.

5. The vehicle auxiliary machine according to claim 4, wherein the interlock plate fastening member is a bolt.

6. The vehicle auxiliary machine according to claim 1, wherein the interlock switch mechanism comprising:
an actuator actuating when the interlock plate is removed from a predetermined position of the inverter cover; and
a switch for stopping the power supply to the inverter circuit unit when the actuator actuates.

7. The vehicle auxiliary machine according to claim 1, wherein the interlock plate is provided with a magnet for actuating the interlock switch mechanism, the vehicle auxiliary machine further comprising a magnetic reaction switch provided on a side of the inverter circuit in opposition to the magnet with the inverter cover disposed therebetween.

8. The vehicle auxiliary machine according to claim 7, wherein the interlock plate facing the inverter cover has a recess for accommodating the magnet.

9. The vehicle auxiliary machine according to claim 7, wherein the magnetic reaction switch is located in the inverter circuit.

10. The vehicle auxiliary machine according to claim 1, wherein the vehicle auxiliary machine is a motor compressor.

11. The vehicle auxiliary machine according to claim 1, wherein the inverter cover fastening member is a bolt.

12. A method for opening an inverter cover of a vehicle auxiliary machine, comprising the steps of:
loosening an interlock plate fastening member;
removing an interlock plate which covers an inverter cover fastening member from a predetermined position;
stopping power supply to an inverter circuit unit;
loosening the inverter cover fastening member; and
removing the inverter cover only after removal of the interlock plate.

13. The method according to claim 12, wherein the interlock plate fastening member has a different shape from the inverter cover fastening member.
